(19) United States
(12) Patent Application Publication
(10) Pub. No.: US 2023/0051496 A1
(43) Pub. Date: Feb. 16, 2023

(54) UNIT-BASED SPORTS GAME BETWEEN UNIT-BASED COMPOSITE TEAMS

(71) Applicant: James J. Calvanio, San Diego, CA (US)

(72) Inventor: James J. Calvanio, San Diego, CA (US)

(21) Appl. No.: 17/821,034

(22) Filed: Aug. 19, 2022

Related U.S. Application Data
(63) Continuation of application No. 16/464,942, filed on May 29, 2019, now abandoned.
(60) Provisional application No. 62/433,041, filed on Dec. 12, 2016.

(51) Int. Cl. A63F 3/06; G07F 17/32

(52) U.S. Cl. CPC A63F 3/0615; G07F 17/3274; G07F 17/326

(57) ABSTRACT

A unit-based game between (at least) first and second composite teams. A football team has at least three units: offense, defense, and at least one special team. A baseball team has at least three units: hitters, fielders, and pitchers. Different types of units on regular teams are ranked, and each composite team is formed from a highly ranked unit of each unit type, where different units on each composite team can come from different regular teams. For NFL football, the first composite team can include the best offense, defense, and special team in the NFC, while the second composite team includes the best offense, defense, and special team in the AFC. For major league baseball, the first composite team can include the best units of hitters, fielders, and pitchers in the NL, while the second composite team includes the best units of hitters, fielders, and pitchers in the AL.

### Cross-Reference to Related Applications

This application is a continuation of U.S. patent application Ser. No. 16/464,942, which claimed the benefit of the filing date of U.S. provisional application no. 62/433,041, filed on Dec. 12, 2016, the teachings of both of which are incorporated herein by reference in their entirety.

### BACKGROUND

### Field of the Invention

The present invention relates to games and, more particularly but not exclusively, to unit-based ball games for league-based sports such as professional and collegiate football and baseball.

### Description of the Related Art

This section introduces aspects that may help facilitate a better understanding of the invention. Accordingly, the statements of this section are to be read in this light and are not to be understood as admissions about what is prior art or what is not prior art.

Baseball All-Star games, football Pro Bowls, and the like are those showcase games in which teams are made up of those individual players who are best at their positions or who accomplished the most during the season. For instance, in major-league baseball, several “best” players from each position in the game (shortstop, pitcher, etc.) are selected from among the various teams. Those in each league are then assigned to their respective teams. These two teams then play each other and one team is declared “the all-star champion”. Individual players' characteristics, such as popularity or performance, are the sole criteria for inclusion in the all-stars playoff, though subjective elements can be used, e.g., when sports writers and fans vote for their favorites.

While the regular season continues, and the team rankings begin to firm up, fans engage in discussions over who will go to the World Series. At the same time, as individual players begin to stand out for their accomplishments during the season, fans become engaged in a media-fed conversation about “who is the best player” in a particular position and is therefore likely to be chosen as an All-Star. The selected players are then assembled into two all-star teams. Fans then begin to debate which of these two teams, composed of their favored and disfavored players, will win the All-Star game. The game is then played, generating in-person and television audiences. This process thus has the effect of augmenting the entertainment value of the sport above and beyond regular season games, providing fans additional opportunities to involve themselves, and providing the leagues and chosen players and teams additional opportunities to engage fans, boost revenues, and add elements to fantasy-based competitions.

### SUMMARY

One embodiment of the present invention is a post-season playoff game or games pitting at least two composite American-rules football teams against each other. Each composite team would be composed of the best offensive, defensive, and special-team units (field goal, punt, kickoff, return) in its respective conference (e.g., AFC, NFC of the National Football League). The results of the final contest, referred to as the BUC Bowl™, would be to determine the Best Unit Championship™ team for the league.

Another embodiment of the present invention is a post-season playoff game or games pitting two or more composite baseball teams against each other. Each composite team would be composed of the best hitting, fielding, and pitching units (starters, relievers) in its respective conference (e.g., AL, NL of Major League Baseball).

Other embodiments may be developed for any sport where players are organized into units of some kind in which group collaboration and performance, as well as individual player performance, determine team success. In football and baseball, different types of units for a composite team are on the field at different times. For example, in football, the offensive and defensive units of a composite team are on the field at different times. Similarly, in baseball, hitting and fielding units of a composite team are on the field at different times.

The invention can also be applied to games in which different types of units of a composite team are on the field at the same time. For example, for soccer, a composite team could include (i) one or more striker units, where each striker unit includes strikers on a regular team, (ii) one or more midfielder units, where each midfielder unit includes midfielders on a regular team, (iii) one or more defender units, where each defender unit includes defenders on a regular team. At any given time, in addition to a goalie, each composite team would deploy, on the field, a striker unit, a midfielder unit, and a defender unit. Analogous composite teams could be formed for other sports such as (without limitation) hockey (with front-line and back-line units in addition to a goalie) and even basketball (with, for example, three-player forecourt units and two-player backcourt units). As used herein, the term “unit” refers a group of two or more participants in a sports game who are members of the same regular team in a sports league or conference having many such teams that compete against each other. Those skilled in the art will understand that, in certain different contexts, the term “unit” is equivalent to terms such as (without limitation) “squad,” “grouping,” “crew,” “subunit,” “sub team,” “corps,” or “lineup”. As used herein, unless explicitly stated or implied otherwise, the term “conference” can refer to any subset of teams in a sports league. As such, in certain different contexts, the term “conference” is equivalent to terms such as (without limitation) “division,” “subdivision,” “grouping,” “seeding,” or “faction.”

### BRIEF DESCRIPTION OF THE DRAWINGS

Embodiments of the invention will become more fully apparent from the following detailed description, the appended claims, and the accompanying drawings in which like reference numerals identify similar or identical elements.

FIG. 1 is a flow diagram of a method of playing a unit-based game according to one embodiment of the invention.

### DETAILED DESCRIPTION

Detailed illustrative embodiments of the present invention are disclosed herein. However, specific structural and functional details disclosed herein are merely representative for purposes of describing example embodiments of the present invention. The present invention may be embodied in many alternate forms and should not be construed as limited to only the embodiments set forth herein. Further, the terminology used herein is for the purpose of describing particular embodiments only and is not intended to be limiting of example embodiments of the invention.

As used herein, the singular forms “a,” “an,” and “the,” are intended to include the plural forms as well, unless the context clearly indicates otherwise. It further will be understood that the terms “comprises,” “comprising,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

### BACKGROUND TO THE CONCEPTION OF THE INVENTION

American-rules football in its early years was a game of generalists, in which players commonly played multiple roles on defense and offense. Since the 1950s, however, it has become a game of specialists working together in units that are used at different times and for different purposes. The offensive unit, for instance, shares little if any personnel with the defensive unit, punting and kicking units only punt and kick, the physiological characteristics and training of the line are very different from those of the running backs, the quarterback specializes in passing, and so on.

For a team to be successful, all of these units have to be good at their specialty. A quarterback is often only as good as the line that protects him, and a great offensive unit cannot overcome the mistakes of a bad defensive unit that allows excessive points to be run up against it. A weak unit will drag down the entire team. A good defense may hold the opposing team to one goal but the offense will get the credit for winning the game by a point. A unit might contain a star player, but, if the other members are weak and cooperate badly, the star player will add little if any value to the team.

In spite of this interdependency, quarterbacks generally are the “stars” whom everyone knows. With occasional exceptions, the units themselves are not the object of fan attention.

The units that make up teams typically vary in abilities and performance—some teams are known for their strong offense, others for their strong defense, and still others for their performance under certain conditions. Seldom does one team contain the very best units in the league under their one roof—though it more frequently happens that a few teams are weak across all their units.

### DETAILS OF THE INVENTION

In certain embodiments, this invention comprises a post-season championship playoff game(s) (“Game”) in which one or more games are played between two or more composite teams whose units (defense, offense, special teams) (“Units”) are chosen from among the top-ranked Units in their respective conferences using a mostly objective analysis, evaluation, and selection process. Each composite team, being drawn from among the very best units in each conference, will be better than any regular team. So, when this composite team competes against its counterpart from another division or conference, it is probable that the difference in skills between the two composite teams will be smaller, the standard of play will be uniformly higher across all phases of play, and the uncertainty about the outcome of the match will be much greater, creating more dramatic intrigue and appeal.

The various football leagues use the nomenclature of league, conference, and division in different ways, but their hierarchical organization differs little. For instance, the following table contains the organization used by the National Football League, but it illustrates the general case for analogous forms of organization in other sports. In the case of the NFL, the organization is as follows: League>2 Conferences>4 Divisions per Conference>4 Teams per Division>Offensive Unit/Defensive Unit/Special-Team Unit per team.

College football, in contrast, uses “Divisions” to describe the top rank of the hierarchy, and “Conferences” to describe the collections of Teams in each Division. The NCAA (National College Athletic Association) contains various college sports, including baseball and football. It divides the sport of football into Divisions, denoting levels of competency and competitiveness, e.g., Division 1 (the powerhouse schools), Division 2 (secondary schools, such as junior colleges), and unranked. Within each Division, there are a multitude of Conferences. Division 1 contains such Conferences as Big 10, Southeastern Conference, the Pac 10, Ivy League, etc.

In other words, identical terms (“Leagues”, “Divisions”, “Conferences”) are used in different ways by different sports associations. Nevertheless, the invention can be applied the same way irrespective of these differences: A large number of Teams playing each other within a grouping comprise a larger number of Units from among which are chosen the best Units that constitute the championship teams that compete in the Best Unit Championship™.

As discussed elsewhere, the invention may be used in both college and professional football, as well as in other sports in which units are used. Its application to NCAA football likely would involve more complexity and possibly more levels of playoffs before arriving at the final playoff game than its application to NFL football, simply because the NCAA contains so many leagues and conferences and levels of play. This would be a highly desirable aspect of the invention.

### Playoff Game Played Between These Two Teams to Yield a Champion

In one embodiment, the best-performing units in each division of four teams are used to compose a composite team. The composite team from each division then plays the composite team(s) from the other division(s). These top units, put together into the same team, can create a composite team that is better than any of the regular teams in the league.

The following text describes the invention's application to one embodiment, a post-season playoff of composite teams in the National Football League of the United States of America.

Units are selected through the application of a method that is highly sensitive to all factors of the games played during the regular season and that provides a method to rank the performance of the Units. For instance, a selection committee may be employed much as in NCAA football to oversee or make a final determination when unit rankings are close in their objective rankings as determined by a rating system based on statistical data.

One selection process may use an in-depth statistics-based method to produce objective rankings for Units, thereby guaranteeing that the Game includes the genuinely best Unit combinations of players. One appropriate method is the Defense-adjusted Value over Average (“DVOA”) introduced by Aaron Schatz in 2003, explained below. (Other methods may be equally functional.)

This invention can benefit league play, teams, and the fan's experience in the following ways:

1. It positively impacts competitive uncertainty;
2. It enhances team dynamics and the competitive balance of the league through the regular season by providing incentives to pursue multiple strategies to achieve winning results. For instance, high-performing Units on teams with otherwise losing records would still have an opportunity to be selected to the Best Unit Championship™ game.
3. It provides additional selection data for nominations to the Hall of Fame;
4. It increases fan base engagement and numbers remaining engaged, contributing to advertising revenues and game attendance;
5. Increased game and television revenues will enhance the ability of additional teams to obtain specific players through transfers and drafts.
6. It increases the efficiency of the betting market by reducing information asymmetries between bettors.
7. It creates an additional element in fantasy play and dynamics.
8. This game will be a unique and interesting contest that garners interest in the general watching public, prolonging the season and allying the depression that comes to many fans whose team was eliminated from contention earlier in the season, or lost in the playoffs or Superbowl.

The selection process for one embodiment uses both annual and multiple-year accumulative data. Longer-duration data tends to wash out stellar but unrepeatable performances as well as catastrophic player loss and other unforeseen impact events. The types of data, collection, and analysis are described in exemplar form in the section below describing the DVOA system.

In one embodiment, statistics from more-recent games would be weighted more heavily than from older games, the purpose being to choose, for the composite teams, those units that are just hitting their peak performance. Using units at the top of their game will make for more-exciting games and a highlight to the end of the regular playing season.

### Choice of Coaches

After Offensive, Defensive, and Special-Team Units are chosen to compose a composite team for the Best Unit Championship™ playoff game(s), coaches are chosen to coach the composite team. This selection process does not affect the core claims of the invention, but concern about choice of coaches is worth discussing to show how choice might be handled so as to strengthen the invention.

The Unit coordinators and their sub-coaches who are already attached to their respective Units are likely to stay on through the Best Unit Championship™ playoff game(s).

Several methods of choosing a head coach may be imagined. For instance, the participating Unit coordinators might make the choice; or the head coaches of the conference might choose; more arbitrarily, the coach of the Unit with the highest degree of superiority above the mean might be chosen; or a dynamic calculation involving consideration of strategy, given the composition of the opposing teams, might be developed.

### An Alternative Embodiment

Offensive and Defensive Units in football are broken down still more finely into sub-units. For instance, the Defensive Unit contains Defensive Line, Linebackers, and Defensive Secondary. The Offensive Unit contains the Offensive Line, Running Backs, Receivers, and Quarterback and Backups. Each of these sub-units has its own positional playbook and sub-coach. The sub-units who together make a Unit share a Unit playbook, and a Unit coordinator manages all the sub-coaches. (Special Teams are generally unitary.)

Because quantitative data exist for the performance of every Unit, sub-unit, and player, it is possible to disaggregate Units into these component sub-units and choose the best sub-units for a Best Unit Championship™ playoff. For instance, the best Offensive Line could be chosen from the Offensive Unit of Team 1 in Chicago, the best Running Backs from Team 2 in Houston, and so on. The effect would be to create composite teams whose Units are nominally even better than the Units that are selected for the Preferred Embodiment. The selection process would be more complex, however, and the coaching and coordination might be more challenging because of the necessity to blend disparate elements in a short amount of time.

A positive aspect would be that a broader fan base would be created because more teams and cities would be touched by the championship process. For instance, a losing team with a loyal but unrequited fan base, if it possessed a “best sub-unit”, could participate in the playoff, invigorate its fans, increase its competitive standing for the following year, and tap a multitude of new revenue sources.

### Examples of the Use of Quantitative Analysis to Select Units for Best Unit Championship™ Game

Various methods exist to analyze games quantitatively. In the NFL, the principal methods are DVOA, AFA, Massey-Peabody Analytics, and Smart Rating System. The first two methods are described below. The invention may use either one, or another, or, as discussed above, a hybrid approach using statistics as a first filter and human judgment as a final filter.

### First Example of Quantitative Analysis: DVOA

“Defense-adjusted Value over Average” (DVOA) possesses common elements that can be found in “Ultimate Zone Rating” (“UZR”) which is a sabermetric statistics algorithm used to measure baseball fielding performance. Sabermetrics is the term used to denote the empirical analysis of baseball, especially baseball statistics that measure in-game activity, and compare actual events to past data averages.

DVOA was introduced by Aaron Schatz in 2003 when he launched a website called Football Outsiders. It can be used to evaluate teams, units, or players. Unlike conventional NFL statistics today, which relies on net yardage figures, it analyzes every play during the NFL season and compares it to a league-average baseline based on comparable situations.

Breaking down every single play of the season, DVOA assigns each play a value based on both total yards and yards towards first down. It then assigns “success points”, e.g., a successful play is worth one point, an unsuccessful play is worth zero points, and fractional points are awarded depending on yards remaining to the first down. There are points awarded for passes 10 yards and longer, for fumbles, and for interceptions. Offense and defense are awarded bonus points for red-zone plays, and there are bonus points for touchdowns. It also takes turnovers and fumbles into account, and accounts for successes converting “third downs and long”, and for creating turnovers caused by incomplete passes.

Every single play during the NFL season receives a “success value” based on this algorithm. That number is then compared to the average success values of plays in similar situations for all units, adjusted for a number of variables, including:

1. Team lead or deficit in the game

2. Time remaining in the game

3. Down and distance to first down

4. Field position

5. Opponent's Ability

6. Success Rate

Each year DVOA is normalized so that league averages for offense and defense are 0%.

Positive DVOA represents a play in favor of offense and negative DVOA favors a play by defense. Defenses are adjusted based on the average success of the offenses they are facing.

Here are the three main advantages of this method:

1. It creates a set of team rankings based on play-by-play efficiency rather than total yards, resulting in more-accurate statistics as to relative team, unit, and player strength of performance;

2. It compares Unit effort in drives and not individual plays to demonstrate strengths and weaknesses in variety of situations; and

3. Normalization improves the accuracy of the comparison of current teams and Units to past teams and Units.

In the game highlighted in this patent description, NFL football, statistics are available to measure the performance of units. Other statistics and algorithms may be developed that make the job of unit and sub-unit measurement easier and more precise, and, in other games, may have to be developed to make this Invention work in that game. Any useful statistical system that does the job can be used in this Invention, however, including selection systems relying on subjective or hybrid subjective-objective rating methods.

### Second Example of Quantitative Analysis: AFA

Another method of statistical analysis of NFL play is called the Advanced Football Analytics (AFA) method. AFA is a system created by Brian Burke. It is referred to as a multivariate non-linear regression model, and it is based on the following eight elements:

Offensive net passing yards per attempt

Offensive rushing yards per attempt

Offensive interceptions per attempt

Offensive fumbles per play

Defensive net passing yards per attempt

Defensive rushing yards per attempt

Team penalty yards per play

Home field advantage

This method determines relative contributions of the running and passing game of a team. The use of the net passing yards per attempt by itself can determine how many wins a team will have in a season. AFA combines both offensive and defensive efficiency as predictors.

Furthermore, this method calculates each team's “logit” with arithmetic game probabilities to create Generic Win Probability (GWP).

Logit is a final number given to every team to measure the team's strength. It is a number derived from all eight elements. This statistical number is used in another arithmetic formula which takes into account home field advantage. Through the use of logits, the formula offers the opportunity to determine a winner in a game.

This method does not assign point values to field position or time of game, nor to which down was being played at the moment the datum was being created. It uses “dummy” weeks of league averages to reduce outlier data and thus creates a good platform for evaluation of offensive, defensive, and special-teams units.

### Third Example of Quantitative Analysis: Standard NFL Ranking System

The standard NFL ranking system might be described as a “default” method of unit selection. Standard NFL statistics include points scored, yards gained, passes completed, and other cumulative records of offensive and defensive activities. For instance, “Best Defense” might be “least number of points given up”; “Best Offense” might be “greatest number of points scored”; “Best Special Team” might be “smallest number of yards given up defending kickoffs plus largest number of yards gained on receiving kickoffs”. These sorts of cumulative statistics lack subtlety but they could be used wholly or in part to select the units that together form the composite teams in a Best Unit Championship™ playoff game.

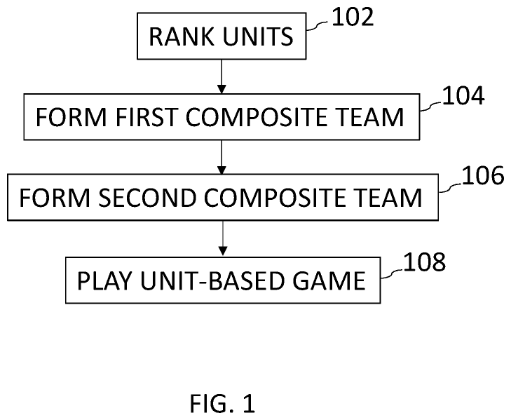

FIG. 1 is a flow diagram of a method of playing a unit-based game according to one embodiment of the invention. The method of FIG. 1 will be described in the context of the unit-based games of American-rules football and baseball. Nevertheless, the method of FIG. 1 can also be implemented in the context of other unit-based games, such as (without limitation) Canadian-rules football. The unit-based game is played on an appropriate playing field configured to simultaneously deploy a unit of two or more players of a first composite team and a unit of two or more players of a second composite team for a sport having multiple multi-unit teams, each team having units of different unit type.

In one possible implementation for football, eleven players of an offensive unit of a first composite team and eleven players of a defensive unit of a second composite team are simultaneously deployed on a football field. At other times during a football game, the first composite team may deploy a special-team unit, while the second composite team deploys its defensive unit. At still other times, the roles of the first and second composite teams are reversed, such that the first composite team deploys its defensive unit, while the second composite team deploys its offensive unit or a special-team unit.

For baseball, a baseball field is configured to simultaneously deploy a hitting unit of a first composite team and a fielding unit plus a pitcher from the pitching unit of a second composite team. Here, too, at other times, the roles of the first and second composite teams are reversed, such that the first composite team deploys its fielding unit and a pitcher from its pitching unit, while the second composite team deploys its hitting unit. In some implementations, the catcher may be part of the pitching unit rather than the hitting unit, although the catcher may still hit when his composite team is at bat. Depending on the implementation, the pitcher might or might not also hit when his composite team is at bat. In some implementations, a composite team may have a starting-pitcher unit comprising a number of starting pitchers and a separate, relief-pitcher unit comprising a number of relief pitchers. As the term “deploy” is used in this specification, even though no more than four baseball players from the batting unit can be on the playing field at any given time, more than four players from the batting unit may said to be “deployed” at a given time.

Each unit of each composite team may have more than the maximum number of players that can be deployed on the playing field at any given time. For example, although no more than eleven football players may be deployed on a football field at a given time, one or more units on a composite football team, such as the offensive and defensive units, may have more than eleven players, where the extra players are available to play as substitutes when needed.

In step 102 of FIG. 1, each unit of each unit type is ranked relative to other units of the same unit type using specified particular performance criteria. For example, in football, each defensive unit is ranked relative to other defensive units, each offensive unit is ranked relative to other defensive units, and each special-team unit is ranked relative to other special-team units of the same type (e.g., punt return, punt defense, kickoff return, kickoff defense, field goal/extra point). In baseball, although most players hit (when their team is at bat) and field (when their team is in the field), each team's performance at hitting is ranked relative to other teams' performances at hitting, and each team's performance at fielding is ranked relative to other teams' performances at fielding. In this way, the hitting unit for a composite baseball team may come from one regular team, while the fielding unit of that composite baseball team comes from another regular team. When the composite team plays baseball, the players on the hitting unit will only hit, and the players on the fielding unit will only field.

Depending on the implementation, the ranking can be performed solely by computer processing, partially by computer processing and partially by human selection, or solely by human selection.

In step 104, the first composite team is formed to include a highly ranked unit of each unit type, and, in step 106, the second composite team is formed to include a highly ranked unit of each unit type. In one possible implementation for NFL football, a composite NFC team is formed comprising an offensive unit, a defensive unit, and one or more special-team units, all from NFC teams, while a composite AFC team is formed comprising an offensive unit, a defensive unit, and one or more special-team units, all from AFC teams. Note that the highly ranked units may be, but do not have to be, the highest-ranked units. For example, if the highest-ranked offensive unit in the NFC is from Philadelphia, but the Eagles are in the Super Bowl, then the Eagles' offensive unit might not be available to play in the BUC™ Bowl, and instead the second-ranked offensive unit from Atlanta may be selected for the NFC's composite team. As another example, if the highest-ranked offensive and defensive teams in the NFC are both from Philadelphia, but the goal is to ensure that each unit in the composite NFC team is from a different regular NFC team, then the second-ranked offensive team from Atlanta may be selected to be on the NFC's composite team.

Note that other implementations are also possible. For example, instead of having an NFC composite team and an AFC composite team, each composite team could have units from any NFL team such that there would be a first NFL composite team and a second NFL composite team, where one or both composite teams have units from both the NFC and the AFC. Alternatively, NFL teams could be divvied up according to some criterion other than conference, for example, by geography, as in North vs. South or East vs. West. Analogous alternative implementations are also possible for baseball and other sports.

In step 108, the unit-based game is played on the playing field between the first and second composite teams. When the unit of a first unit type of the first composite team (e.g., the offensive unit of an NFC composite team) is deployed to compete on the playing field, the unit of a second unit type of the second composite team (e.g., the defensive unit of an AFC composite team) is deployed to compete on the playing field against the unit of the first unit type of the first composite team, and, when the unit of second unit type of the first composite team (e.g., the defensive unit of the NFC composite team) is deployed to compete on the playing field, the unit of the first unit type of the second composite team (e.g., the offensive unit of the AFC composite team) is deployed to compete on the playing field against the unit of the second unit type of the first composite team.

The invention can be implemented in the context of professional sports, such as (without limitation) American or Canadian football or major or minor league baseball. The invention can also be implemented in the context of amateur sports, such as (without limitation) collegiate football or baseball, where the different composite teams may correspond to different collegiate conferences. For example, a Big Ten composite football team could play against an SEC composite football team. Here, too, restrictions on the selection of the highly ranked units for the composite teams can be applied to ensure that the BUC™ Bowl is not just a game between the Ohio State football team and the Alabama football team.

Depending on the implementation, a composite football team could have two or more of the following special-team units:

a first special-team unit comprising a first long-snapper, a placeholder, and a field-goal/extra-point kicker;

a second special-team unit comprising a second long-snapper and a punter;

a third special-team unit comprising a kickoff kicker and a number of kickoff-return defenders;

a fourth special-team unit comprising at least one kickoff returner and a number of kickoff-return blockers;

a fifth special-team unit comprising at least one punt returner and a number of punt-return blockers; and

a sixth special-team unit comprising a number of punt-return defenders.

In some implementations, each unit on a composite football team may be smaller than an entire offensive or defensive squad. For example, in one possible implementation, a composite football team could have an offensive-line unit, a passing unit (including quarterbacks, tight ends, and wide receivers), a running-back unit, a defensive-line unit, a linebacker unit, and a defensive-back unit (including safeties), where each unit can be (but does not have to be) from a different regular team.

For football, the playing field is a generally rectangular playing field having (i) a first end line and a second, opposing end line, a distance between the end lines defining a length of the playing field; (ii) opposing side lines defining boundaries of play and a distance between the side lines defining a width of the playing field; and (iii) first and second goal lines parallel to the first and second end lines and spaced inwardly therefrom. The ball has the general shape of an oblong spheroid similar to that of an American football. A goal is associated with each of the end lines such that the goal defines a scoring area elevated above the playing field.

The offensive unit of the first composite team is deployed having as an objective to move the ball across the first goal line, without a player on the offensive unit of the first composite team or the ball moving outside of the boundaries of play, wherein movement of the ball is accomplished by a player on the offensive unit of the first composite team optionally (i) running with the ball or (ii) passing the ball to another player on the offensive unit of first composite team. The defensive unit of the second composite team is deployed having as an objective to defend the first goal line by stopping the movement of the ball by the offensive unit of the first composite team toward the first goal line, wherein the movement can be stopped by players of the defensive unit of the second composite team by either optionally (i) tackling a player of the offensive unit of the first composite team who is carrying the ball or (ii) disrupting a pass from one player of the offensive unit of the first composite team to another player of the offensive unit of the first composite team.

The offensive unit of the first composite team is provided with a predetermined number of successive plays to move the ball a predetermined distance wherein each play can be ended when a player on the offensive unit of the first composite team or the ball travels outside the boundary of play, or optionally the defensive unit of the second composite team either (i) tackles a player of the offensive unit of the first composite team who is carrying the ball or (ii) disrupts a pass from one player of the offensive unit of the first composite team to another player of the offensive unit of the first composite team. A special-team unit of the first composite team is deployed to attempt to kick the ball at the goal to score one or more points.

For baseball, the playing field has (i) a quadrilateral-shaped infield defined at its four corners by a home plate and first, second, and third bases and having a pitcher's mound located between the home plate and the second base; (ii) an outfield located between the infield and an outfield barrier; (iii) a first-base foul line defined as a straight line extending from the home plate through the first base to the outfield barrier; and (iv) a third-base foul line defined as a straight line extending from the home plate through the third base to the outfield barrier, wherein the first-base and third-base foul lines define a field of play for the unit-based baseball game. A ball has the general shape of a spheroid similar to that of an American baseball.

The hitting unit of the first composite team is deployed having as an objective to advance players of the hitting unit of the first composite team from the home plate around the first, second, and third bases and back to the home plate by hitting the ball within the field of play. The fielding unit and the at least one pitching unit of the second composite team are deployed having as an objective to get players of the hitting unit of the first composite team out.

Depending on the implementation, two composite teams can play one or more games on one or more playing fields. For example, in a best-of-seven Best Unit Championship™ baseball series, an NL composite team and an AL composite team may play up to seven different games of baseball on up to seven different baseball fields corresponding to seven of the MLB teams having units in the composite teams.

Unless explicitly stated otherwise, each numerical value and range should be interpreted as being approximate as if the word “about” or “approximately” preceded the value or range.

It will be further understood that various changes in the details, materials, and arrangements of the parts which have been described and illustrated in order to explain embodiments of this invention may be made by those skilled in the art without departing from embodiments of the invention encompassed by the following claims.

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. A method of playing a modified football game on a physical football field, the method comprising:
(a) fielding an American Football Conference (AFC) composite team comprising (i) an offensive squad consisting of human football players from a first AFC team of the National Football League (NFL) and (ii) a defensive squad consisting of human football players from a second AFC team of the NFL different from the first AFC team;
(b) fielding a National Football Conference (NFC) composite team comprising (i) an offensive squad consisting of human football players from a first NFC team of the NFL and (ii) a defensive squad consisting of human football players from a second NFC team of the NFL different from the first NFC team; and
(c) playing the modified football game on the physical football field between the AFC composite team and the NFC composite team, wherein:
when the AFC composite team is on offense, the offensive squad from the first AFC team competes against the defensive squad from the second NFC team;
when the NFC composite team is on offense, the offensive squad from the first NFC team competes against the defensive squad from the second AFC team;
human football players on the offensive squad from the first AFC team are forbidden from playing on the defensive squad of the AFC composite team;
human football players on the defensive squad from the second AFC team are forbidden from playing on the offensive squad of the AFC composite team;
human football players on the offensive squad from the first NFC team are forbidden from playing on the defensive squad of the NFC composite team; and
human football players on the defensive squad from the second NFC team are forbidden from playing on the offensive squad of the NFC composite team.

2. The method of claim 1, wherein:
the AFC composite team further comprises a special-teams squad consisting of human football players from a third AFC team of the NFL different from the first and second AFC teams;
the NFC composite team further comprises a special-teams squad consisting of human football players from a third NFC team of the NFL different from the first and second NFC teams;
the special-teams squad from the third AFC team competes against the special-teams squad from the third NFC team;
human football players on the special-teams squad from the third AFC team are forbidden from playing on the offensive and defensive squads of the AFC composite team;
human football players on the offensive and defensive squads of the AFC composite team are forbidden from playing on the special-teams squad of the AFC composite team;
human football players on the special-teams squad from the third NFC team are forbidden from playing on the offensive and defensive squads of the NFC composite team; and
human football players on the offensive and defensive squads of the NFC composite team are forbidden from playing on the special-teams squad of the NFC composite team.

3. The method of claim 1, wherein:
the physical football field is a generally rectangular playing field having:
(i) a first end line and a second, opposing end line, 120 yards between the end lines defining a length of the playing field;
(ii) opposing side lines defining boundaries of play and a distance between the side lines defining a width of the playing field; and
(iii) first and second goal lines parallel to the first and second end lines and spaced inwardly therefrom by 10 yards each;
(d2) providing an American football having the general shape of an oblong spheroid;
(d3) providing goal posts in association with each of the end lines such that the goal defines a scoring area elevated above the playing field;
(d4) deploying the offensive unit of the AFC composite team having as an objective to move the ball across the first goal line, without a human player on the offensive unit of the AFC composite team or the ball moving outside of the boundaries of play, wherein movement of the football is accomplished by a human player on the offensive unit of the AFC composite team optionally
(i) running with the football; or
(ii) passing the football to another human player on the offensive unit of AFC composite team;
(d5) deploying the defensive unit of the NFC composite team having as an objective to defend the first goal line by stopping the movement of the football by the offensive unit of the AFC composite team toward the first goal line, wherein the movement can be stopped by human players of the defensive unit of the NFC composite team by either optionally
(i) tackling a human player of the offensive unit of the AFC composite team who is carrying the ball, or
(ii) disrupting a pass from one human player of the offensive unit of the AFC composite team to another human player of the offensive unit of the AFC composite team;
(d6) providing the offensive unit of the AFC composite team with a predetermined number of successive plays to move the ball a predetermined distance wherein each play can be ended when a human player on the offensive unit of the AFC composite team or the ball travels outside the boundary of play, or optionally the defensive unit of the NFC composite team either
(i) tackles a human player of the offensive unit of the AFC composite team who is carrying the ball; or
(ii) disrupts a pass from one human player of the offensive unit of the AFC composite team to another human player of the offensive unit of the AFC composite team; and
(d7) deploying a special-teams unit of the AFC composite team to attempt to kick the football at the goalposts to score one or more points.

4. The method of claim 1, wherein the football game is played multiple times on two or more different football fields, wherein:
at least one of the football fields corresponds to a real-world team of the AFC conference; and
at least one of the playing fields corresponds to a multi-unit real-world team of the NFC conference.
